(19) United States
(12) Patent Application Publication
(10) Pub. No.: US 2013/0237175 A1
(43) Pub. Date: Sep. 12, 2013

(54) ADAPTIVE MOBILE MESSAGING INTERFACE FOR IMPLEMENTING EMERGENCY PROTOCOLS

(71) Applicant: RAVE WIRELESS, INC., Framingham, MA (US)

(72) Inventor: William Todd Piett, Southborough, MA (US)

(73) Assignee: Rave Wireless, Inc., Framingham, MA (US)

(21) Appl. No.: 13/792,716

(22) Filed: Mar. 11, 2013

Related U.S. Application Data
(60) Provisional application No. 61/609,611, filed on Mar. 12, 2012.

(51) Int. Cl. H04W 4/12

(52) U.S. Cl. CPC H04W 4/12
USPC 455/404.1

(57) ABSTRACT

A method for using text to communicate with a 9-1-1 caller includes receiving an emergency message from a 9-1-1-caller using a mobile device, presenting, on a display screen of the mobile device, a first text message, presenting, on the display screen of the mobile device, a first set of valid responses to the first text message, and receiving, from the mobile device, information identifying a selection of a valid response from the first set of valid responses.

### PRIORITY CLAIM

This application claims the benefit of the priority date of U.S. Provisional Application 61/609,611, filed on Mar. 12, 2012, the contents of which are herein incorporated by reference.

### FIELD OF DISCLOSURE

This disclosure relates to text-based communication system, and in particular, emergency communication systems.

### BACKGROUND

Communication via different types of mobile messaging media has become commonplace. Over a trillion SMS messages are sent every year in the U.S. alone. Instant messaging applications are also becoming widely used on mobile devices. Other forms of messaging such as real-time text are also growing in their use.

Despite the many advantages of text-based messages, there remain some disadvantages that hinder their use in emergency communications.

First of all, conversations via text often take longer than corresponding voice communications. In a typical emergency, time is of the essence. A victim of a heart attack, or an accident, is hardly in a position to wait for a return text message. Text communications also lack verbal cues, thus further hindering communication. In addition, it can be stressful to be typing on a small keypad during an emergency. Typing is inherently slower than speaking, and more prone to mistakes.

### SUMMARY

The invention features an adaptive user interface that speeds communication between individuals in situations in which a scripted interaction prompts one party to respond from a finite set of most likely responses. Such an interface can be adapted to numerous uses, one of which is emergency communications.

In one aspect, the invention features a method for using text to communicate with a caller. Such a method includes receiving an emergency message from a mobile device, presenting, on a display screen of the mobile device, a first text message and a first set of responses to the text message, and receiving, from the mobile device, information identifying a selection from the first set of responses.

Some practices further include receiving a second text message, the second text message being chosen based on the selection from the first set of responses.

Other practices further include receiving information indicative of capabilities of the mobile device, and defining the first set of responses at least in part based on the information.

In another aspect, the invention features a method for using text to communicate with a 9-1-1 caller. Such a method includes receiving an message from a 9-1-1- caller using a mobile device, presenting, on a display screen of the mobile device, a first text message, presenting, on the display screen of the mobile device, a first set of valid responses to the first text message, and receiving, from the mobile device, information identifying a selection of a valid response from the first set of valid responses.

Some practices of the method also include presenting, on the display screen of the mobile device, a second text message, the second text message being chosen based on the selection of a valid response to the first text message.

Other practices include receiving information indicative of equipment on the mobile device, and defining the first set of valid responses at least in part based on the information.

In yet other practices, there exists a further step of including receiving information indicative of equipment on the mobile device, and remotely controlling operation of the equipment.

Also included among the various practices are those in which presenting a first set of responses to the text message includes presenting an option inviting the caller to actuate selected equipment on the mobile device.

Among other practices are those that also include receiving, at a public safety answering point, the selection of a valid response, and based on the selection, identifying one or more suitable second text messages for potential display on the display screen of the mobile device.

In another aspect, the invention features an apparatus for text based communication between a public safety answering point and a 9-1-1 caller. Such an apparatus includes a protocol database for storing a set of protocols; and a protocol controller for selecting a protocol from the protocol database and controlling the protocol in response to information about equipment on a mobile device from which a 9-1-1 call is received.

Some embodiments also include a mobile-device controller for remote control of equipment on the mobile device. Among these are embodiments in which the protocol controller is configured to cause text communication to be displayed on a display screen of the mobile device and to cause a set of valid responses to be displayed on the display screen.

In other embodiments, the protocol controller is further configured for presenting, on the display screen of the mobile device, a second text message, the second text message being chosen based on a selection by the 9-1-1 caller of a valid response to the first text message.

In yet other embodiments, the protocol controller is further configured for receiving information indicative of equipment on the mobile device, and defining the first set of valid responses at least in part based on the information.

Among the other embodiments are those in which the protocol controller is configured to present an option inviting the 9-1-1 caller to actuate selected equipment on the mobile device and those in which the protocol controller is further configured for receiving, at a public safety answering point, a selection of a valid response from the 9-1-1 caller, and based on the selection, to identify one or more suitable second text messages for potential display on a display screen of the mobile device.

Other aspects of the invention include software encoded in a tangible and non-transitory computer-readable medium for implementing the foregoing method and a particular computer to which the method is tied. Tangible and non-transitory computer-readable media divide generally into two broad categories: (1) those that comply with 35 USC 101 at the time of filing this application, and (2) all others. Applicant, acting as his own lexicographer, hereby expressly defines “computer-readable medium” as used in the claims as including only those of the first type and excludes those of the second type.

All methods recited in the claim are hereby restricted to only those methods that are tied to a particular machine and that are not abstract. Abstract practices of the method that do not comply with 35 USC 101 as of the filing date of this application are hereby excluded from the scope of the claims.

These and other aspects of the invention will be apparent from the following detailed description and the accompanying figures, in which:

### BRIEF DESCRIPTION OF THE FIGURES

FIG. 1 shows a communication system for communication with a 9-1-1 caller;

FIG. 2 shows an exemplary user interface implemented by the system in FIG. 1 in which response options are presented based on a question selected by the call taker;

FIG. 3 shows an exemplary user interface in which a question is chosen by a call taker based on knowledge of the device capabilities of the caller's mobile device, with the response options optionally including launching device functions such as taking a picture;

FIG. 4 is an exemplary user interface like that in FIG. 3 but received on a mobile device that lacks a camera; and

FIG. 5 is an example of a user-interface that shows a video.

### DETAILED DESCRIPTION

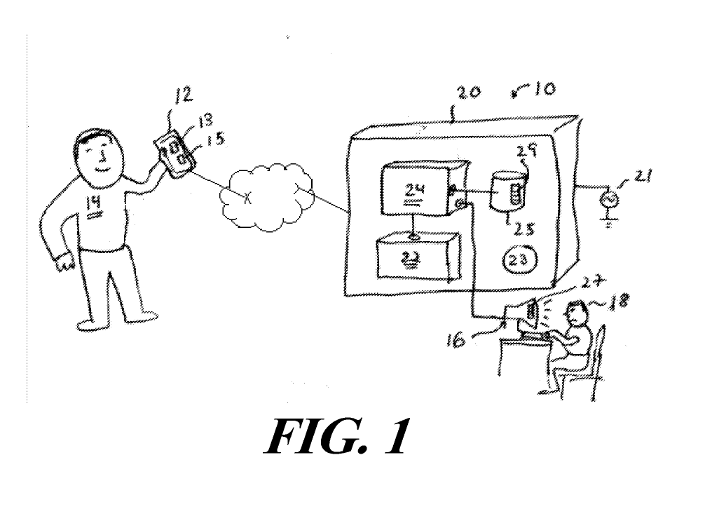

FIG. 1 shows a public safety answering point (“PSAP”) 10 adapted to carry out two-way text communication between a mobile device 12, which is used by a 9-1-1 caller 14, and a stationary device 16 used by an emergency-call taker 18. The communication may be over any number of common protocols, including but not limited to, email, SMS,XMPP, or RTT via SIP.

A processing system 20 implements a mobile-device controller 22, a protocol controller 24, and a protocol repository 25. In some embodiments, the processing system 20 is located at the PSAP 10. However, the particular location of the processing system 20 is not of great importance. In other embodiments, the processing system 20 is located remotely and accessed via a computer network.

The processing system 20 is a particular machine that has been specially programmed to carry out the methods described herein. It is a tangible physical machine that consumes electricity provided by a voltage source 21 and generates waste heat. As used herein, the term “processing system” is not intended to mean “software per se.” The processing system 20 implements machine-readable instructions that are stored in a non-transitory and tangible computer readable medium 23.

The protocol controller 24 executes protocols 29, or steps, that help ensure a consistent level of care in the interaction between the 9-1-1 caller 14 and the emergency-call taker 18. These protocols 29 are stored in the protocol repository 25. Following these protocols 29 also helps avoid missing critical details that may affect the nature of the units dispatched or the location to which they are dispatched. These relatively rigid protocols 29, often referred to as EMD (emergency medical dispatch), EFD (emergency fire dispatch) and EPD (emergency police dispatch) also provide some liability protection.

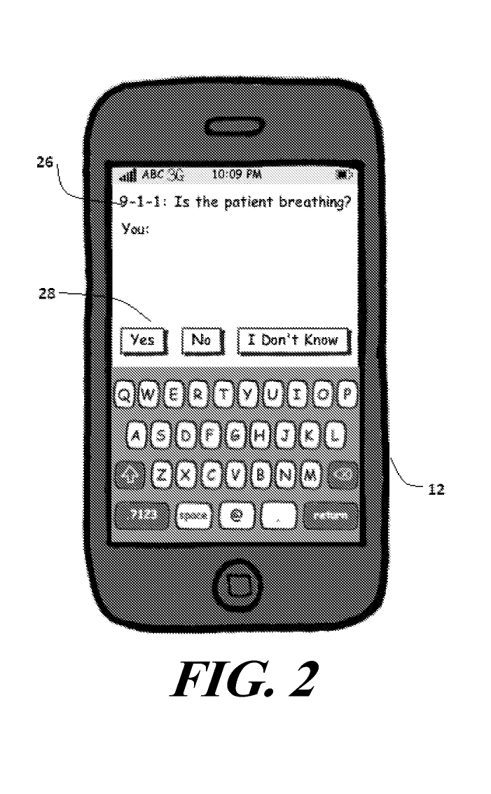

The protocol controller 24 provides guided questions to which the 9-1-1 caller 14 responds. A typical question 26 from a series of guided questions provided by the protocol controller 24 is displayed on the mobile device 12, as shown in FIG. 2.

Typically, one or more pre-defined text messages 26 are provided on a list 27 presented to the emergency-call taker 18. The emergency-call taker 18 then types a text message, which can be selected from the list 27, and sends it to the mobile device 12. In addition, the emergency-call taker can simply select a pre-defined text messages 26 from the list 27, to avoid having to type it. Or, the emergency-call taker 18 can also deviate from the protocol 29 by typing in any text message, such as a question, an instruction, or words of reassurance and comfort including, for example, the status of any assistance that has been dispatched to assist the 9-1-1 caller 14.

In some embodiments, much of the communication is handled by the protocol controller 24 with the emergency-call taker 18 being available primarily as a back-up in case human interventions is required.

The interface on the mobile device 12 automatically displays a set of valid responses 28 to a received text message 26. In the example shown in FIG. 2, valid responses 28 include “yes,” “no,” and “I don't know.” The 9-1-1 caller 14 then selects an appropriate response from the set of valid responses 28. The valid responses 28 are driven by the question flow and can also be influenced by the specific capabilities of the device, its location of the device, or other data accessible by the device, such as, but without limitation, ambient temperature, GPS location, and external noises. The ability to select a response 28 avoids the delay associated with a flustered 9-1-1 caller 14 attempting to compose and type a response. The 9-1-1 caller's selection of a valid response 28 is then sent to the protocol controller 24.

In response, the protocol controller 24 selects a next text message based on the caller's response. This allows the interaction with the 9-1-1 caller 14 to be adaptive.

The adaptive interaction between the PSAP 10 and the 9-1-1 caller 14 is more than merely an adaptive communication in which a protocol controller 24 selects next text messages based on a user's response to preceding text messages. The adaptive interaction can also include exploitation of the mobile device 12 itself to gather further information to assist the emergency-call taker 18 in determining the needs of the 9-1-1 caller 14.

The mobile-device controller 22 receives information concerning the capabilities of the mobile device 12. This information can come from the mobile device 12 itself, or from a database of registration information provided by the user, or by simply having the emergency-call taker 18 ask the 9-1-1 caller 14.

For example, the mobile device 12 may have a camera, in which case a photograph can be made available to the emergency-call taker 18. This photograph could then provide the emergency-call taker 18 with important clues on the nature of the emergency.

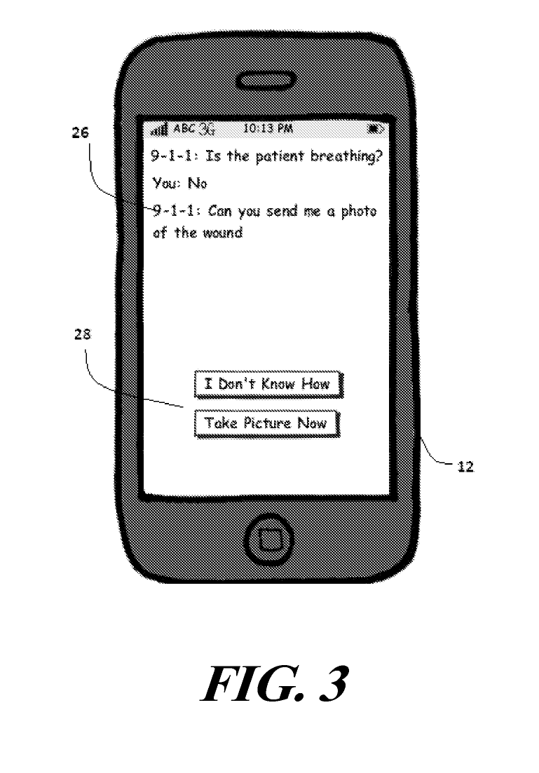

The mobile-device controller 22 provides, to the protocol controller 24, information concerning equipment 13 on the mobile device 12. Based on this, the protocol controller 24 may instruct the 9-1-1 caller 14 to activate particular equipment, as shown in FIG.3.

In FIG. 3, the set of valid responses 28 includes responses other than textual responses. For example, a valid response 28 includes activating selected equipment, such as taking a picture, or issuing a declarative statement, such as communicating an inability to operate such equipment.

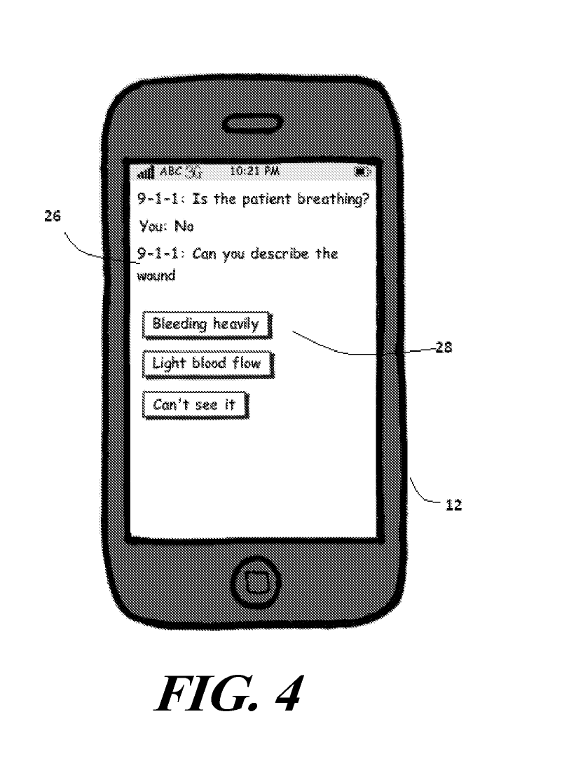

As shown in FIG. 4, the user-interface accommodates the absence of particular equipment 13. For example, in the case of a mobile device 12 that lacks camera equipment, the set of valid responses 28 includes solicitation of information that can be provided in the absence of such equipment.

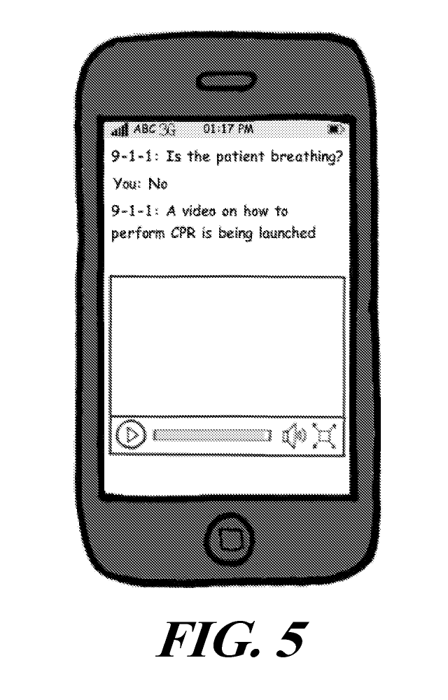

In some cases, the protocol controller 24 determines that certain information would be especially useful to the 9-1-1 caller 14. For example, if based on the communication the protocol controller 24 concludes that a patient's heart has stopped, it may provide instructions on how to perform CPR. Such instructions may be displayed as text, still photographs or diagrams, or as a video, as shown in FIG. 5.

Equipment 13 includes hardware equipment, such as a camera, or speaker, as well as software equipment, such as various apps or software for driving hardware equipment. For example, the protocol controller 24 can instruct the mobile device 12 to activate its camera equipment and to take a photograph. By recognizing whether or not the mobile device 12 has particular equipment, the protocol controller 24 avoids instructing the 9-1-1 caller 14 or instructing the emergency call-taker 18 to activate a non-existent equipment.

The emergency-call taker 18 is also able to remotely activate equipment 13 on the mobile device 12 by using the mobile-device controller 22. For example, when faced with an unresponsive 9-1-1 caller 14, the emergency-call taker 18 may remotely activate the speaker on the mobile device 12, or activate the video camera to get a better sense of the situation. Because of privacy concerns, preferably there exists a permissions and security layer 15 to ensure that these features can only be invoked when appropriate, such as during emergency communication.

A variety of functions on a mobile device 12 can be remotely activated. For example, the mobile-device controller 22 may poll a GPS unit to identify the caller's location. Or the mobile-device controller 22 may activate an alarm or other sound generating mechanism on the mobile device 12, or a strobe light on the mobile device 12. The mobile-device controller 22 may also access the caller's contact list on the mobile device 12 to identify anyone who perhaps should be contacted in case of emergency.

Although the emergency-call taker 18 communicates for the most part according guidance provided by the protocol controller 24, there continues to be an opportunity to communicate by typing in text in the conventional way. Accordingly, the 9-1-1 caller 14 also has the opportunity to communicate by typing in text.

In some embodiments, analytics are applied to optimize scripting flows based on past history, or to make suggestions to the emergency-call taker 18 based on factors such as a delay in the response time, or the use of certain key words, such as words indicating frustration or stress.

Having described the invention, and a preferred embodiment thereof, what is claimed as new and secured by letters patent is:

1. A method for using text to communicate with a 9-1-1 caller, said method comprising receiving an emergency message from a 9-1-1- caller using a mobile device, presenting, on a display screen of said mobile device, a first text message, presenting, on said display screen of said mobile device, a first set of valid responses to said first text message, and receiving, from said mobile device, information identifying a selection of a valid response from said first set of valid responses.

2. The method of claim 1, further comprising presenting, on said display screen of said mobile device, a second text message, said second text message being chosen based on said selection of a valid response to said first text message.

3. The method of claim 1, further comprising receiving information indicative of equipment on said mobile device, and defining said first set of valid responses at least in part based on said information.

4. The method of claim 1, further comprising receiving information indicative of equipment on said mobile device, and remotely controlling operation of said equipment.

5. The method of claim 1, wherein presenting a first set of responses to said text message comprises presenting an option inviting said caller to actuate selected equipment on said mobile device.

6. The method of claim 1, further comprising receiving, at a public safety answering point, said selection of a valid response, and based on said selection, identifying one or more suitable second text messages for potential display on said display screen of said mobile device.

7. An apparatus for text based communication between a public safety answering point and a 9-1-1 caller, said apparatus comprising a protocol database for storing a set of protocols; and a protocol controller for selecting a protocol from said protocol database and controlling said protocol in response to information about equipment on a mobile device from which a 9-1-1 call is received.

8. The apparatus of claim 7, further comprising a mobile-device controller for remote control of equipment on said mobile device.

9. The apparatus of claim 8, wherein said protocol controller is configured to cause text communication to be displayed on a display screen of said mobile device and to cause a set of valid responses to be displayed on said display screen.

10. The apparatus of claim 7, wherein said protocol controller is further configured for presenting, on said display screen of said mobile device, a second text message, said second text message being chosen based on a selection by said 9-1-1 caller of a valid response to said first text message.

11. The apparatus of claim 7, wherein the protocol controller is further configured for receiving information indicative of equipment on said mobile device, and defining said first set of valid responses at least in part based on said information.

12. The apparatus of claim 7, wherein said protocol controller is configured to present an option inviting said 9-1-1 caller to actuate selected equipment on said mobile device.

13. The apparatus of claim 7, wherein said controller is further configured for receiving, at a public safety answering point, a selection of a valid response from said 9-1-1 caller, and based on said selection, to identify one or more suitable second text messages for potential display on a display screen of said mobile device.

14. A manufacture comprising a non-transitory computer readable medium having encoded thereon software for controlling text communications with a 9-1-1 caller, said software comprising instructions that are tied to a particular machine and that cause said particular machine to receive an emergency message from a 9-1-1-caller using a mobile device, to present, on a display screen of said mobile device, a first text message, to present, on said display screen of said mobile device, a first set of valid responses to said first text message, and to receive, from said mobile device, information identifying a selection of a valid response from said first set of valid responses.

15. The manufacture of claim 14, wherein said software further comprises instructions for causing a data processing system to present, on said display screen of said mobile device, a second text message, said second text message being chosen based on said selection of a valid response to said first text message.

16. The manufacture of claim 14, wherein said software further comprises instructions for causing a data processing system to receive information indicative of equipment on said mobile device, and to define said first set of valid responses at least in part based on said information.

17. The manufacture of claim 14, wherein said software further comprises instructions for causing a data processing system to receive information indicative of equipment on said mobile device, and to remotely control operation of said equipment.

18. The manufacture of claim 14, wherein said instructions for causing a data processing system to present a first set of responses to said text message comprise instructions to cause said data processing system to present an option inviting said caller to actuate selected equipment on said mobile device.

19. The manufacture of claim 14, wherein said software further comprises instructions for causing a data processing system to receive, at a public safety answering point, said selection of a valid response, and based on said selection, to identify one or more suitable second text messages for potential display on said display screen of said mobile device.
